(19) United States
(12) Patent Application Publication
(10) Pub. No.: US 2026/0290971 A1
(43) Pub. Date: Sep. 24, 2026

(54) COMPRESSION PAD FOR ARRANGING BATTERY CELLS IN A SPACED MANNER AND METHOD FOR PRODUCING SAME, AND BATTERY PACK HAVING SUCH A COMPRESSION PAD

(71) Applicant: Carcoustics TechConsult GmbH, Leverkusen (DE)

(72) Inventors: Christoph LENTJES, Krefeld (DE); Ines LEIB, Köln (DE); Paul SCHÖNZART, Leverkusen (DE); Michael TERHORST, Aachen (DE)

(21) Appl. No.: 19/490,214

(22) PCT Filed: Jun. 7, 2024
(86) PCT No.: PCT/EP2024/065731

§ 371 Date: Dec. 4, 2025

(30) Foreign Application Priority Data
Jun. 9, 2023 (DE) 10 2023 115 159.2

(51) Int. Cl. H01M 50/242; H01M 50/209; H01M 50/211; H01M 50/213; H01M 50/291; H01M 50/293

(52) U.S. Cl. CPC H01M 50/242; H01M 50/291; H01M 50/293; H01M 50/209; H01M 50/211; H01M 50/213

(57) ABSTRACT

A compression pad for the spaced arrangement of battery cells in a battery pack, including a flat compression layer with a length, a width and a thickness, wherein the length and width are multiples of the thickness, wherein the compression layer includes first and second lateral surfaces, each of which is spanned by the length and width. The compression pad is characterized in that the compression layer includes macroscopic regions extending on the first lateral surface and/or second lateral surface with different compressive stiffnesses, wherein the compressive stiffness is measured in the orthogonal direction to the first lateral surface and/or second lateral surface.

### CROSS-REFERENCE TO RELATED APPLICATIONS

This application is a 35 U.S.C. § 371 National Stage patent application of no. PCT/EP2024/065731, filed on 7 Jun. 2024, which claims the benefit of German patent application no. 10 2023 115 159.2, filed on 9 Jun. 2023, the disclosures of which are incorporated herein by reference in their entirety.

### TECHNICAL FIELD

The disclosure relates to a compression pad for the spaced arrangement of battery cells in a battery pack. The present disclosure furthermore relates to a method for producing such a compression pad, as well as a battery pack with a plurality of battery cells arranged apart from each other with at least one such compression pad.

### BACKGROUND

In the technical field of vehicle technology, an increasing number of battery packs are being used, which are composed of a large number of individual battery cells. For this purpose, the individual battery cells are usually assembled in a housing to form a battery pack. It is important that the battery cells are securely positioned in the housing.

In this technical field, the term battery is used synonymously with the term accumulator so that a battery is also to be understood, in particular, as a rechargeable accumulator.

The battery cells are also subject to temperature fluctuations, which lead to temperature expansion. Depending on the type of battery used, the battery cells also tend to breathe during charging and discharging, i.e., to expand and contract again, or to expand or not contract again due to aging processes and/or improper handling. This expansion behaviour is particularly pronounced in lithium-based batteries.

A certain amount of mechanical compression of the battery cells can support the battery cells in this expansion and contraction, thus increasing the efficiency of the battery cells and improving the performance or capacity in the direction of the end of their life cycle. This can increase the service life of the battery cells.

Therefore, in the state of the art, compression pads are used in the battery packs, which are arranged between the battery cells and between the battery cells and the housing. These compression pads comprise a certain compressive stiffness or, in other words, a certain flexibility, which allows the battery cells to be pre-tensioned against each other and against the housing with a certain compressive stress, thus supporting the battery cells in particular during expansion and contraction. In contrast to a rigid arrangement, the flexibility of the compression pads allows the battery cells to expand and contract again—particularly against the elastic force of the compression pads—particularly supported by the elastic force of the compression pads. The occurrence of excessive compressive stresses between the battery cells or the housing can also be avoided.

However, the expansion of the battery cells does not take place homogeneously in all spatial directions. In cylindrical battery cells, the centre of the cylinder can expand more than the two circular ends of the battery cell so that the battery cell assumes a barrel shape. Cuboid battery cells or pouch cells or prismatic cells tend to expand in a cushion-like manner, particularly in such a way that bulges form in the middle of the rectangular surfaces. These inhomogeneous expansions mean that the compression pads can no longer sufficiently compensate for the expansion in the regions with greater expansion of the battery cells, resulting in unintentionally high compressive stresses, while only low compressive stresses occur in the regions of the battery cells with lower expansion. If the compressive stresses become too high, the housing can burst, or the battery cells can be damaged.

Further prior art can be found in documents US2021/249662A1 , US2013/252063A1, and CN 2019 144 372 U.

### SUMMARY

The present disclosure is therefore based on the task of providing an improved compression pad which reduces the compressive stresses occurring due to the expansion of the battery cells compared to prior art, wherein the battery cells are nevertheless securely positioned in the housing.

The problem is solved by the subject-matter and method of independent patent claims. Preferred embodiments of the present disclosure result from the features mentioned in the subclaims and furthermore from the present disclosure as a whole.

A first aspect of the disclosure concerns a compression pad for the spaced arrangement of battery cells in a battery pack. For this purpose, the compression pad comprises a flat compression layer with a length, a width and a thickness, wherein the length and width are many times the thickness, wherein the compression layer comprises a first lateral surface and a second lateral surface, each of which is spanned by the length and width. The compression pad preferably comprises two flat protective layers, of which one protective layer is preferably arranged on the first lateral surface and one protective layer is preferably arranged on the second lateral surface of the compression layer. The disclosure is characterized in that the compression layer comprises a plurality of macroscopic regions extending on the first lateral surface with different compressive stiffnesses, wherein the compressive stiffness is preferably measured in the orthogonal direction to the first lateral surface and is considered averaged over the respective region. The compression layer comprises recesses extending from the first lateral surface to the second lateral surface to effect the regions with different compressive stiffnesses, wherein the recesses are arranged in such a way that the number of recesses and/or the total cross-sectional area of the recesses is greater in a middle region of the first and/or second lateral surface than in the edge regions, wherein the middle region extends along at least part of a centre line between two longitudinal sides of the first and/or second lateral surface on the first and/or second lateral surface, and wherein the edge regions each extend along at least part of a longitudinal side, wherein the recesses are arranged in such a way that the number of recesses and/or the cumulative cross-sectional area of the recesses decreases from the centre line in the direction of the longitudinal sides.

In the regions with greater compressive stiffness, there is initially a higher compressive stress at the beginning, i.e., when the battery cells are mounted in the housing, which allows the battery cells to be held securely in position. The regions with higher compressive stiffness are preferably arranged in such a way that no or only small expansions of the battery cells are to be expected in them so that the compressive stresses set at the beginning preferably remain essentially constant. The regions with lower compressive stiffness respond to compression due to the expansion of the battery cells with a lower increase in compressive stress so that the maximum compressive stresses can be lowered due to expansion in these regions. In addition, a prerequisite is created for equalizing the counterpressure exerted by the compression pad on an expanding battery cell.

Preferably, the compression layer is configured in such a way that the compression layer is compressed to about 70% of its thickness in the unstressed state at the beginning of the battery pack's lifetime, i.e., when the battery cells are mounted in the housing, in order to achieve the preload for the battery cells. In the direction of the end of the battery pack's life, the compression layer can then be compressed to about 30% of its unstressed thickness due to the expansion of the battery cells. In particular, a compression curve of the compression layer is linear between a compression of 70% and 30%. The compression in percent refers to the thickness of the compression layer in the assembled state, i.e., stressed, in relation to the thickness of the compression layer in an unstressed state. The compression curve relates this percentage compression to the compressive stress that is applied to the compression layer.

Both the compression pad and the compression layer as well as the protective layers are flat. For the purposes of the application, flat means that the pads or layers comprise a rectangular shape whose length and width are many times higher than the thickness. Typically, the width is 20 to 150 mm, and the length is 50 to 500 mm. The thickness of the whole compression pad can be 0.1 to 5 mm. In particular, the width is 80 to 120 mm, the length is 200 to 300 mm, and the thickness is 1 to 3 mm. A thickness of 1.6 mm for the entire compression pad turned out to be particularly preferred. The length and width can be adapted to existing battery cells. For example, a width of the compression pad can correspond to the height of a cylindrical battery cell, or the width or length of a cuboid battery cell, or a multiple thereof. With regard to existing battery cells, a length of 517 mm or 550 mm and a width of 101 mm have therefore turned out to be particularly preferable.

The thickness of the compression layer alone can be 0.5 to 2.5 mm, particularly 1.2 mm. The thickness of the protective layer alone can be 0.01 to 0.5 mm, particularly 0.1 to 0.3 mm. In practice, a thickness of 0.2 mm has proven to be particularly preferred. The length and width of the protective layer is adapted to the length and width of the compression layer and corresponds to it in particular.

An additional adhesive layer can be placed between the compression layer and the protective layer. Additional adhesive layers can also be arranged on the side of the protective layer facing away from the compression layer, for example to attach further functional layers or to attach to the battery cells. For example, a dispersion-based polyacrylate (polyacrylic acid ester) can be used as an adhesive layer.

The compression layer comprises regions with different compressive stiffnesses. These regions have macroscopic dimensions. In the application, macroscopic means that the regions are a plurality of millimetres in size and can be up to a plurality of centimetres or a plurality of decimetres in size. This does not mean microscopic regions of a few millimetres or tenths of a millimetre in size and below. This is not intended to take into account fluctuations in compressive stiffness that occur due to individual pores or fibre gaps in the material of the compression pads, as these do not reflect the compressive stiffness of the material itself.

An important aspect of the disclosure is reflected in the fact that the compressive stiffness of the compression layer is set to a lower level where the battery cells expand most over their service life due to aging processes or the like. Cuboid or prismatic cells bulge out in a cushion-shaped manner at their faces so that the expansion of the battery cell is greatest in the middle of the surfaces of the cuboid or prism and decreases in the direction of edges. In cylindrical battery cells, the expansion is greatest halfway up the cylinder and decreases in the direction of the circular end faces. Therefore, the compressive stiffness of the compression layer in the contact region at half the height of the cylinder should be set less than in the direction of the ends of the cylinder. The same applies to cuboid or prismatic battery cells.

As a rule, the region of the compression layer that comprises a lower compressive stiffness corresponds to the region around a centre line that results between the two longitudinal sides of the compression layer. This region is called the middle region. Particularly for the use of the compression pad in cuboid or prismatic battery cells, the middle region can extend along a centre line that is arranged between the two edges, which extend in the width of the compression pad. This creates a middle region in the middle of the first and/or second lateral surface of the compression layer.

The regions of higher compressive stiffness extend along the longitudinal sides of the compression layer and extend from there in the direction of the centre line. These regions are called edge regions. In addition, other regions can be provided that lie between the regions with the highest and lowest compressive stiffness, and whose compressive stiffness is between the highest and lowest compressive stiffness. These regions are called intermediate regions. Preferably, the middle region is adjacent to the intermediate regions, and the intermediate regions is adjacent to the edge regions, wherein neither the middle region and intermediate regions nor the edge regions and intermediate regions overlap.

The compressive stiffness can be influenced by material parameters of the compression layer. For example, in the case of a porous material, it is a good idea to vary the pore size or the density of the pores over the width of the compression layer. A higher density of pores, i.e., a higher number of pores in relation to a certain volume, leads to a lower compressive stiffness, as well as an enlargement of the pores. In the case of a fibre material, the density of the fibres and the spacing of the fibres can be adjusted analogously.

According to the disclosure, the insertion of recesses, for example by punching or lasering recesses into the compression layer so that continuous holes are created in the flat compression layer. This can simplify production compared to influencing the compressive stiffness by material parameters. By having one or two protective layers in place, a sudden change in the compressive stiffness of the compression pad as a whole in the region of the recesses of the compression layer can be avoided.

In addition, depending on the manufacturing method of the compression layer or the application, a minimum thickness of the compression layer can be required, which is actually larger than desired. These regions in particular can be influenced and optimized in their compressive stiffness by inserting recesses. For example, if the thickness of the compression layer is actually too high, which has to be compressed to a required lower thickness, the compression layer comprises a low compliance and high compressive stiffness so that the flexibility can be increased again or the compressive stiffness can be reduced by inserting recesses.

Therefore, the compression pad in one embodiment comprises a compression layer that comprises recesses that extend in an orthogonal direction from the first lateral surface to the second lateral surface.

Preferably, only the compression layer is provided with recesses so that any protective layers retain their contiguous surface, and, for example, a flame-retardant effect of the protective layers is maintained.

According to the disclosure, the recesses are arranged in such a way that the number of recesses and/or the total cross-sectional area of the recesses in a middle region of the compression layer is greater than in the edge regions. The middle region extends along a centre line between two longitudinal sides of the compression layer and extends in particular in the direction of the longitudinal sides. The edge regions are adjacent to the longitudinal sides and extend along the longitudinal sides, wherein the edge regions extend, in particular, from the longitudinal sides in the direction of the centre line. The middle region and the edge region can be adjacent to each other, or adjacent to other regions such as the intermediate region. However, the individual regions do not overlap.

The extension of the middle region can be symmetrical from the centre line in both directions to the longitudinal sides of the compression layer so that the recesses are then also arranged symmetrically to the centre line.

The compressive stiffness can be influenced by the number of recesses. The more recesses are inserted into the compression layer in relation to a certain region, the lower the compressive stiffness in this region, since the compressive stiffness is considered averaged over the entire region. Preferably, in relation to the compression pad as a whole, the protective layers contribute to the averaging of the compressive stiffness. The cumulative cross-sectional area of the recesses in relation to a certain region is decisive. The larger the cumulative cross-sectional area of the recesses, i.e., the negative region, in relation to a certain region, the lower the compressive stiffness. Accordingly, in addition to the number of recesses, the size of the cross-sectional area of the recesses can also be varied in order to adjust the compressive stiffness of the compression layer in the individual regions.

In one embodiment, in cylindrical battery cells, the battery cells are arranged with their longitudinal axis parallel to the width of the compression pad or the compression layer so that the regions with lower compressive stiffness are arranged in the middle of the battery cell. The centre of the battery cell is situated halfway up the longitudinal axis of the cylindrical battery cell, or halfway up the longitudinal axis in the case of a cuboid battery cell, wherein the length is greater than the width and thickness of the battery cell, or halfway up the prism in the case of a prismatic battery cell. The expansions due to aging of the battery cell are greatest in these regions and decrease in the direction of the edge regions.

According to the disclosure, the recesses are arranged in such a way that the number of recesses and/or the total cross-sectional area of the recesses decreases from the centre line in the direction of the longitudinal sides. Ideally, the compressive stiffness increases in the direction of the longitudinal sides, i.e., in the direction of the edge regions so that the compressive stiffness is adapted to the course of the expansion of the battery cell in the various regions. It is also conceivable that the recesses are distributed between two edges extending in width, analogous to a centre line. The two centre lines are then orthogonal to each other. Regions of the battery cell with high expansion are preferentially in contact with regions of the compression pad or compression layer with low compressive stiffness, and regions of the battery cell with lower expansion are preferentially in contact with regions of the compression pad or compression layer with higher compressive stiffness. Of course, this refers to the assembled state of the battery cells with the compression pads in a battery pack.

The number of recesses or the summed cross-sectional area of the recesses can therefore also be based on a distribution profile, which determines how large the density of the recesses should be in relation to an area depending on the distance from the centre line, or how large the summed cross-sectional area should be in relation to an area depending on the distance from the centre line. In this case, the number of recesses or the cumulative cross-sectional area across the individual regions is not constant but decreases with increasing distance from the centre line.

In another embodiment of the compression pad, the recesses comprise an oblong shape and extend parallel to the longitudinal sides of the compression layer. In addition to a circular or elliptical shape, oblong shapes can also prove to be beneficial. Such an oblong shape can be, for example, an oblong hole or a rectangle with a width whose length is a plurality of times the width of the rectangle.

In another embodiment of the compression pad, the oblong recesses are designed and arranged in such a way that the compression layer is divided into a plurality of, unconnected strips. The individual strips of the compression layer in the compression pad can preferably be held in position relative to each other by one or two protective layers.

In this embodiment, the oblong recesses correspond to rectangular recesses, the length of which corresponds to the length of the compression pad. The fact that the stripes are not connected to each other means in this context that the individual stripes are not directly connected to each other and therefore also do not touch each other. However, the strips can be connected via other elements such as the protective layers for example.

Preferably, the compression layer or pad is configured in such a way that it provides thermal insulation between the battery cells.

In another embodiment of the compression pad, the compression layer is made of PE foam (polyethylene foam). Polyethylene is a cost-effective plastic that is conditionally heat-resistant, for example up to 100° C., depending on the embodiment, and is therefore suitable for use in battery packs. Battery packs rarely reach more than 100° C. during operation, as the service life of the battery packs is too severely limited at higher temperatures. The PE is present as foam, wherein the compressive stiffness of such a PE foam layer is within a usable range for battery pack production. By applying one or two protective layers to the compression layer, the PE can be protected from the heat of the batteries to a limited extent. The number and size of the pores of the PE foam can be individually adjusted during the pro-duction of the compression layer so that the compressive stiffness can be influenced.

In particular, cross-linked PE is suitable as a material for the compression layer so that in one embodiment the compression layer is made of cross-linked PE foam. In the context of this publication, this refers in particular to chemically or physically cross-linked PE foam in which the polymer chains are chemically or physically connected to each other at certain points and form a three-dimensional network. Cross-linked PE is also known as PEX. The mechanical and thermal properties of cross-linked PE are usually better than those of normal PE. Compared to thermoplastic, i.e., the normal PE mentioned above, cross-linked PE does not melt and is more thermally resistant.

The compression layer can also be made of, for example, PUR foam (polyurethane foam), PO foam (polyolefin foam) or a melamine resin foam. The compression layer can preferably consist of one or a plurality of the aforementioned foams.

A compression layer made of or consisting of cross-linked PO foam (analogous to the cross-linked PE foam described above) is preferable.

Compacted PUR foam can also serve as a material for the compression layer. Compacted PUR foam can be a total compacted PUR foam that has been mechanically compressed, or a PUR foam whose surface has been compacted. The compaction of the surface can be done either mechanically or thermally. If the compression layer consists of PUR foam, at least one of the surfaces of the compression layer can be compacted, for example at least the surfaces of the compression layer that have direct or indirect contact with the battery cells. The compression of the PUR foam has a positive effect on the mechanical properties of the material. The pore structure of the foam can also be influenced by compaction. Therefore, the compression layer is preferably made of a compressed PUR foam or consists entirely of it.

A compression layer made of or consisting of high-temperature foam, such as melamine resin foam, can also be beneficial for example.

The compressive stiffness of a suitable compression layer, in particular PE foam, PUR foam, PO foam or melamine resin foam, as well as its cross-linked or compacted form, can be in the range of 150 to 200 kPa, in particular 160 to 180 kPa, at a compression of 50%.

In another embodiment, the compression layer comprises or consists of a non-foamed material. The non-foamed material can be, for example, an elastomer rubber. Elastomer rubber is made of natural rubber and/or synthetic rubber.

It is also conceivable that the compression layer is made of or consists of a silicone foam.

The compression pad preferably comprises one or two flat protective layers. If a protective layer is present, it is arranged on the first or second lateral surface of the compression layer. If two protective layers are provided, one protective layer is placed on the first lateral surface and the other protective layer is placed on the second lateral surface of the compression layer.

In another embodiment of the compression pad, one or two protective layers are flame-retardant protective layers. Flame retardants are substances that can burn under the supply of heat, but do not continue to burn on their own when the heat supply is interrupted.

For example, a protective layer that is made of mica or at least contains a significant amount of mica can be used as a flame-retardant protective layer.

Mica is also known as sheet mica or mica group and comprises a group of minerals made up of phyllosilicates. The protective layer can consist to a large extent of mica, wherein the protective layer for the mechanical stabilization of the mica can comprise a matrix or a matrix material.

The mica can be arranged on a mat, particularly a mesh mat. A coating of the mica and/or the compression layer with fleece is also conceivable.

The protective layer can protect both the compression layer from heat and flames as well as the battery cells from each other. For example, a defective battery cell can start to burn, and the flames emanating from that battery cell can be pre-vented from spreading to other battery cells by the protective layers.

Preferably, one or two protective layers are made of a mineral-based material. Mineral-based materials comprise an inorganic base and are in contrast to organic-based materials. Mineral-based materials comprise a mineral, non-metallic component such as lime, cement, gypsum or silicate. Natural minerals such as sand, natural stone or clay, as well as all combinations of the substances mentioned in this section, can also be considered as such a component. For example, a protective layer of mica is made of mineral-based. The protective layers can also consist exclusively of one of the components referred to in this section or a combination of these components.

A second aspect of the disclosure relates to a method for producing a compression pad comprising the following steps:
a. providing a compression layer, of a length, a width and a thickness, wherein the length and width are many times the thickness, wherein the compression layer comprises a first lateral surface and a second lateral surface, each spanned by length and width;
b. inserting recesses in the compression layer to influence the compressive stiffness of the compression layer in at least one predefined macroscopic region of the first and/or second lateral surface, wherein the recesses extend from the first lateral surface to the second lateral surface, and the recesses are arranged in such a way that, in a middle region of the first and/or second lateral surface, the number of recesses and/or the summed cross-sectional area of the recesses is greater than in the edge regions, wherein the middle region extends along at least part of a centre line between two longitudinal sides of the first and/or second lateral surface on the first and/or second lateral surface, and wherein the edge regions each extend along at least part of a longitudinal side, wherein the recesses are arranged in such a way that the number of recesses and/or the summed cross-sectional area of the recesses from the centre line in the direction of the longitudinal sides.

In an embodiment of the method, the procedure can also comprise the following steps:
c. applying an adhesive layer to the first lateral surface and the second lateral surface of the compression layer;
d. applying a protective layer to each of the two adhesive layers from step c.

In the case of the method, the compression layer is first provided with recesses in order to obtain the desired compressive stiffness distribution on the surface of the compression layer. After inserting the recesses, it is preferable to apply one adhesive layer to the first lateral surface and the second lateral surface of the compression layer. With the help of these adhesive layers, the two protective layers are preferably attached to the compression layer.

In an embodiment of the method, the procedure can also comprise the following steps:
e. applying an adhesive layer to each of the two protective layers;
f. applying an adhesive film to each of the two adhesive layers from step e.

Alternatively, and analogously to the application of two protective layers, the method can also comprise the application of only one protective layer to the first or second lateral surface of the compression layer. Steps e and f can be performed either only on the protective layer applied to the compression layer, or both on the protective layer applied to the compression layer as well as on the lateral surface of the compression layer on which no protective layer is applied.

Additional adhesive layers can be applied to the protective layers, particularly on the side facing away from the compression layer, which serves to attach one or a plurality of adhesive films to the protective layers. The adhesive film can be used, for example, to attach the entire compression pad to the battery cells and can also be self-adhesive.

The layers and films can be provided on rolls, from which the layers and films are fed into the manufacturing process by unrolling. First, the compression layer is unrolled, wherein the adhesive layers are rolled off onto the unrolled compression layer. The protective layers are then rolled off onto the adhesive layers. The layers can be pressed together with the help of rollers. If a thermally activated adhesive layer, such as a thermoplastic adhesive layer, is used, the layers can also be bonded together by heat in addition to being pressed by the rollers. The adhesive layers can be provided on a carrier film, which is removed again after the adhesive layers have been applied.

A third aspect of the disclosure relates to a battery pack with at least one compression pad according to the disclosure, wherein the battery pack comprises individual electrically connected battery cells which are spaced apart from each other by means of the compression pads.

In the battery pack, the battery cells are arranged relative to the compression pad in such a way that the regions of the compression pad or the compression layer with lower compressive stiffness, such as the middle region, coincide with the regions of the battery cells that expand the most in the course of use so that the expansion of the battery cells can be compensated for as well as possible by the compression pad.

The battery cells of the battery pack can each comprise their own rigid housing. Also in this embodiment, it can be favourable to arrange the battery cells apart from each other by means of the compression pads. For this purpose, the compression pads can be situated in the housings of the battery cells and/or between these housings.

Preferably, the battery cells of the battery pack do not comprise their own, rigid housing. In particular, the battery pack comprises a single, namely an external, rigid housing.

The battery pack preferably comprises cuboid battery cells. The battery pack preferably comprises pouch cells and/or prismatic cells. The battery pack can comprise cylindrical cells

As a general rule, all features disclosed herein with regard to certain aspects or embodiments can also be combined with other aspects or embodiments of the disclosure in a technically sensible way. This also applies across different technical objects and categories of objects. In particular, this also applies in excerpts to individual features, as long as it is not explicitly pointed out herein or it is obvious from a technical contradiction that there is an inseparable functional-technical connection between certain features which must be retained in order to implement the disclosure.

### BRIEF DESCRIPTION OF THE DRAWINGS

In the following, the disclosure is explained by means of exemplary embodiments and schematic drawings. Hereby, the figures show:

FIG. 1 a cut-out of a compression pad to illustrate the layered structure,

FIG. 2 a compression layer with three regions, each with different compressive stiffnesses,

FIG. 3 a compression layer composed of a plurality of strips,

FIG. 4 a compression pad in a battery pack of nine battery cells,

FIG. 5 a compression pad in a cross-sectional illustration between two cylindrical battery cells, which are inhomogeneously extended,

FIG. 6 a compression pad in a cross-sectional illustration between two cuboid battery cells, which are inhomogeneously extended,

FIG. 7 the compression pad from FIG. 2 between two cylindrical battery cells, and

FIG. 8 a compression layer with three regions, each with different compressive stiffnesses for cuboid battery cells.

### DETAILED DESCRIPTION OF THE DRAWINGS

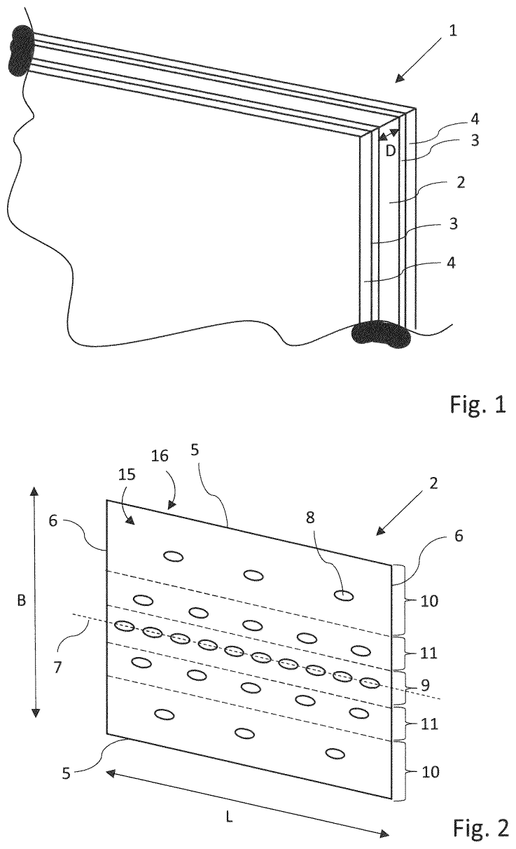

FIG. 1 shows a section of a compression pad 1 to illustrate the layered structure. In the middle there is a compression layer 2, on the first lateral surface 15 and second lateral surface 16 of which an adhesive layer 3 is respectively arranged. A protective layer 4 is applied to each of the two adhesive layers 3. The thicknesses of the individual layers are not realistically reproduced in proportion but are only intended to reflect the layered structure schematically. For example, an adhesive layer 3 would be much thinner in reality.

FIG. 2 shows the compression layer 2 with two longitudinal sides 5 and two side edges 6. The thickness is not shown here for illustration reasons. Between the two longitudinal sides 6 a centre line 7 is drawn.

The compression layer 2 is provided with recesses 8, which comprise a larger number in a middle region 9 around the centre line 7 than in a edge region 10. Between the middle region 9 and the edge regions 10 are arranged two intermediate regions 11, which comprise a number of recesses 8 between the number of recesses 8 of the middle region 9 and the edge region 10. The recesses are arranged symmetrically to the centre line 7, as the expansion of the battery cells 13 is also greatest at the centre line 7 and decreases symmetrically in the direction of the edge regions 10.

The compressive stiffness of the individual regions 9, 10 and 11 is influenced by the recesses 8. Due to the high number of recesses 8 in the middle region 9, this comprises the lowest compressive stiffness, while the small number of recesses 8 in the edge regions 10 leads to the highest compressive stiffness. The compressive stiffness of the intermediate regions 11 lies between the compressive stiffness of the middle region 9 and the edge region 10.

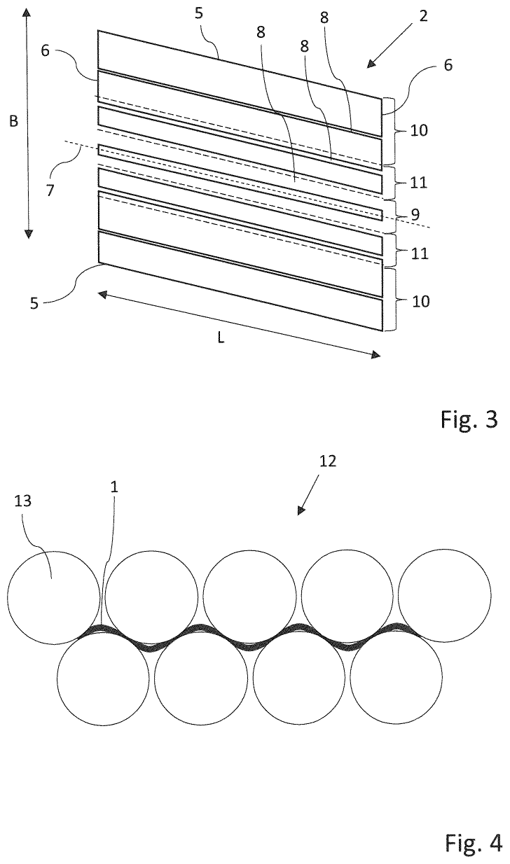

FIG. 3 shows another embodiment of compression layer 2 with rectangular recesses 8, the size of which is chosen in such a way that compression layer 2 is divided into individual strips. The recesses 8 are wider in the middle region 9 than in the edge region 10 and in the intermediate region 11, while the recesses 8 in the edge region 10 are smaller than in the intermediate region 11. This has the same effects on the compressive stiffness of regions 9, 10 and 11 as described in FIG. 2.

FIG. 4 shows a compression pad 1 in a battery pack 12 consisting of nine individual cylindrical battery cells 13, wherein battery pack 12 is not fully represented. It is easy to see here how the compression pad 1 is compressed to a low thickness between the battery cells 13 and comprises a greater thickness in the other regions.

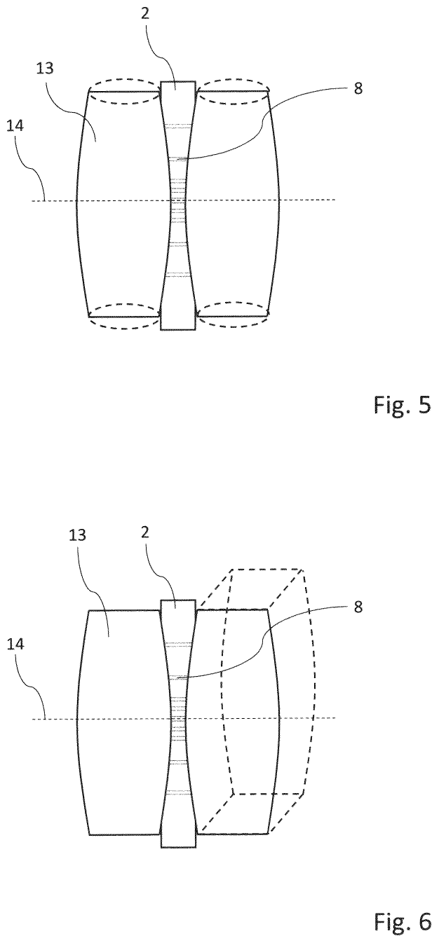

FIG. 5 shows a compression pad 1 between two originally cylindrical battery cells 13 in a cross-sectional image, wherein the battery cells 13 are already inhomogeneously extended. The illustration of the expansion of the battery cells 13 is exaggerated, but it reflects the basic geometry of such aged battery cells 13 well. It can be seen that the battery cells 13 in the middle region halfway up 14 of the original cylindrical shape comprise the greatest expansion and now comprise a barrel- or bin-like shape. This is where compression layer 2 is most compressed so that most of the recesses 8 are also provided there so that the compressive stiffness of compression layer 2 is lowest there and the compressive stresses can be kept as low as possible.

FIG. 6 also shows a compression pad 1 between two battery cells 13 in a cross-sectional image like FIG. 5, except that here battery cells 13 originally had a cuboid shape and are now cushion-shaped. The principle of the recesses 8 of the compression pad 1 is the same. At the level of the largest expansion of the battery cells 13, most of the recesses 8 are provided. See also FIG. 8, with a compression pad 1 particularly for cuboid battery cells 13.

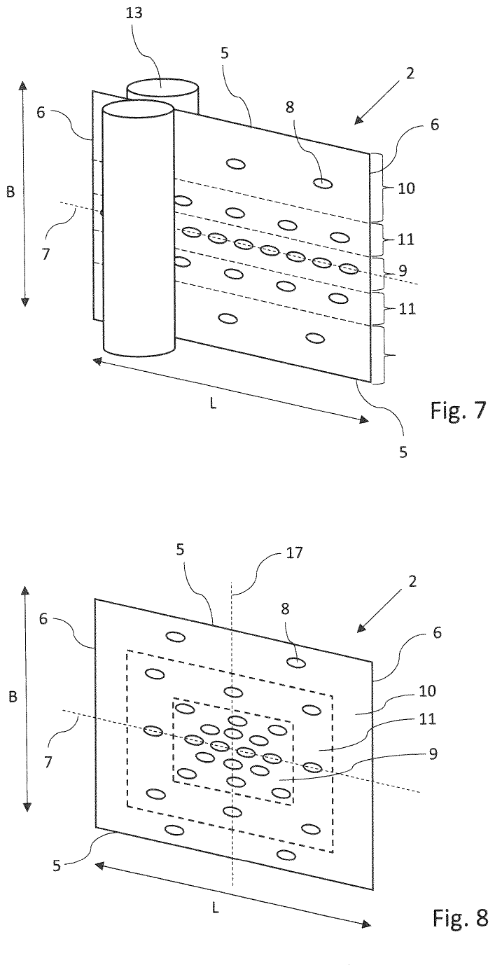

FIG. 7 shows the compression pad 1 from FIG. 2 as an example between two cylindrical battery cells 13. In this diagram it can be seen very well that the density of the recesses 8 is greatest in the region of the halfway height of the cylindrical battery cells 13, which coincides with the centre line 7, and decreases in the direction of the edge regions 10, since the greatest expansions of the battery cells 13 are to be expected in the middle region 9, while the smallest expansions are to be expected in the edge region 10.

FIG. 8 shows a compression layer 2 with two longitudinal sides 5 and two side edges 6 particularly for cuboid battery cells 13. The thickness D is not shown here for illustration reasons. Between the two longitudinal sides 6 a centre line 7 is drawn, and between the two side edges 6 a lateral edge centre line 17.

The compression layer 2 is provided with recesses 8, which comprise a larger number in a middle region 9 around the centre line 7 and the side edge centre line 17 than in an edge region 10. Between the middle region 9 and the edge region 10 there is an intermediate region 11, which comprises a number of recesses 8 between the number of recesses 8 of the middle region 9 and the edge region 10. The recesses 8 are arranged symmetrically to the centre line 7 and the lateral edge centre line 17, since the expansion of the cuboid battery cells 13 is also greatest at the intersection of the two centre lines 7 and 17 and decreases symmetrically in the direction of the edge region 10.

The compressive stiffness of the individual regions 9, 10 and 11 is influenced by the recesses 8. Due to the high number of recesses 8 in the middle region 9, this comprises the lowest compressive stiffness, while the small number of recesses 8 in the edge region 10 leads to the highest compressive stiffness. The compressive stiffness of the intermediate region 11 lies between the compressive stiffness of the middle region 9 and the edge region 10.

1. A compression pad for the spaced arrangement of battery cells in a battery pack, comprising a flat compression layer comprising a length, a width and a thickness, wherein the length and the width are multiples of the thickness, wherein the compression layer comprises a first lateral surface and a second lateral surface, which are spanned by length and width, respectively,
wherein the compression layer comprises a plurality of macroscopic regions extending on the first and/or second lateral surface with different compressive stiffnesses, wherein the compressive stiffness is preferably measured in the orthogonal direction to the first and/or second lateral surface, wherein the compression layer comprises recesses for the effect of the areas with different compressive stiffnesses, extending from the first lateral surface to the second lateral surface, and the recesses are arranged such that in a central region of the first and/or second lateral surface the number of recesses and/or the summed cross-sectional area of the recesses is greater than in the edge regions, wherein the middle region extends along at least part of a midline between two longitudinal sides of the first and/or second lateral surface on the first and/or second lateral surface, and wherein the edge regions each extend along at least part of a longitudinal side, wherein the recesses are arranged such that the number of recesses and/or the summed cross-sectional area of the recesses decreases from the centre line in the direction of the longitudinal sides.

2. (canceled)

3. (canceled)

4. (canceled)

5. The compression pad according to claim 1,
wherein the recesses comprise an oblong shape and extend parallel to the longitudinal sides of the compression layer.

6. The compression pad according to claim 1,
wherein the compression layer comprises or is made from PO foam.

7. The compression pad according to claim 6,
wherein the PO foam is a cross-linked PO foam.

8. The compression pad according to claim 1,
wherein the compression layer comprises PUR foam.

9. The compression pad according to claim 1,
wherein the compression layer comprises high-temperature foam.

10. The compression pad according to claim 1,
wherein the compression layer comprises a non-foamed material.

11. The compression pad according to claim 1,
wherein the compression pad comprises at least one flat protective layer, which is arranged on the first lateral surface or the second lateral surface of the compression layer, wherein the compression pad preferably comprises two flat protective layers, of which one of the two protective layers is arranged on the first lateral surface and the other of the two protective layers is arranged on the second lateral surface of the compression layer.

12. The compression pad according to claim 11,
wherein the protective layer or the protective layers are made of a mineral-based material.

13. The compression pad according to claim 11,
wherein the protective layer or the protective layers contain mica or are made from it.

14. A method for producing a compression pad, the method includes the following steps:
a. providing a compression layer, comprising a length, a width and a thickness, wherein the length and the width are multiples of the thickness, wherein the compression layer comprises a first lateral surface and a second lateral surface, which are spanned by the length and the width respectively; and
b. inserting recesses into the compression layer to influence the compressive stiffness of the compression layer in at least one predefined macroscopic region of the first and/or the second lateral surface, wherein the recesses extend from the first lateral surface to the second lateral surface, and the recesses are arranged in such a way that, in a middle region of the first and/or second lateral surface, the number of recesses and/or the summed cross-sectional area of the recesses is greater than in the edge regions, wherein the middle region extends along at least part of a centre line between two longitudinal sides of the first and/or second lateral surface on the first and/or second lateral surface, and wherein the edge regions each extend along at least part of a longitudinal side, wherein the recesses are arranged in such a way that the number of recesses and/or the summed cross-sectional area of the recesses decreases from the centre line in the direction of the longitudinal sides.

15. The method according to claim 14,
the method further including the following steps:
c1. applying an adhesive layer to the first lateral surface or to the second lateral surface of the compression layer;
d1. applying a protective layer to the adhesive layer from step c1;
e1. applying an adhesive layer to the protective layer from step d1; and
f1. applying an adhesive film to the adhesive layer from step e1; or
c2. applying an adhesive layer to the first lateral surface and to the second lateral surface of the compression layer;
d2. applying a protective layer to each of the two adhesive layers from step c2;
e2. applying one adhesive layer to each of the two protective layers from step d2; and
f2. applying an adhesive film to each of the two adhesive layers from step e2.

16. The method according to claim 14,
wherein the compression layer, the adhesive layers, the protective layer or the protective layers and/or the adhesive film or adhesive films are provided on rolls and are rolled on top of each other and pressed together for application.

17. The method according to claim 14,
wherein the adhesive layers are provided on a carrier film, which is removed again after the adhesive layers have been applied.

18. A battery pack comprising at least one compression pad according to claim 1, wherein the battery pack comprises individual electrically connected battery cells which are spaced apart from each other by means of the compression pads.
